(19) United States
(12) Patent Application Publication
(10) Pub. No.: US 2006/0272102 A1
(43) Pub. Date: Dec. 7, 2006

(54) Strength and abrasion resistance of durable press finished cellulosic materials

(75) Inventors: Jim Liu, Raleigh, NC (US); Sonya Salmon, Raleigh, NC (US); Hui Xu, Wake Forest, NC (US); Caroline Shi, Quincy, MA (US)

Correspondence Address: NOVOZYMES NORTH AMERICA, INC., 500 FIFTH AVENUE, SUITE 1600, NEW YORK, NY, 10110, US

(73) Assignee: Novozymes North America, Inc., Franklinton, NC (US)

(21) Appl. No.: 10/565,024

(22) PCT Filed: Apr. 4, 2003
(86) PCT No.: PCT/US03/10399

§ 371 Date: Sep. 30, 2004

Related U.S. Application Data
(60) Provisional application No. 60/370,301, filed on Apr. 5, 2002.

(51) Int. Cl. C09B 67/00

(52) U.S. Cl. 8/401

(57) ABSTRACT

The invention relates to a method for improving the abrasion resistance and tensile strength of durable press finished cellulosic materials, such as cotton. According to the method of the present invention the cellulosic material is treated with an enzyme composition capable of removing cross links from the cellulosic material, especially cross links on the material surface.

### FIELD OF THE INVENTION

The present invention is directed to a method for improving the abrasion resistance and tensile strength of durable press finished cellulosic materials such as cotton. More particularly, the invention is directed to a method for improving the abrasion resistance and tensile strength by treating the durable press finished cellulosic material with an enzyme composition.

### BACKGROUND OF THE INVENTION

Durable press finishing is widely used in the textile industry to impart wrinkle-resistance to cellulosic materials such as cotton fabric and garments. Durable press finishing agents such as dimethyl dihydroxyethyleneurea (DMDHEU) and dimethylolpropylcarbamate (DMPC) react to form covalent crosslinks between the cellulose polymers in order to impart wrinkle resistance to the cotton fabric. Crosslinking of the cellulose at the fiber/fabric surface, which may be acerbated by migration of the reactant to the surface during the drying and curing resulting in increased crosslinking at the surface, results in increased embrittlement of the fiber surface and a decreased abrasion resistance. Significant loss of mechanical strength and abrasion resistance of the durable press finished fabric have been a major concern for the industry. The cross-linking of cellulose molecules by formaldehyde based resins and with polycarboxylic acid, such as BTCA causes stiffening of the cellulosic macromolecular network and fiber embrittlement thus reducing the mechanical strength of the treated cotton fabric. These same mechanisms are responsible for the reduced mechanical properties of the fiber surface thus leading to poorer abrasion resistance.

There have been numerous approaches for improving strength retention of durable press treated cotton fabrics, including improved treatment efficiency to decrease the amount of catalyst applied and use of polymeric resins to obtain more flexible cross-linking of the fibers.

Lickfield et al.: Abrasion Resistance Of Durable Press Finished Cotton (http://www.ntcresearch.org/current/year10/Projects/C00-C01.htm) discloses the developing of a technology for improving the abrasion resistance of durable press finished cotton fabrics by preventing and/or removing the crosslinks in the fabric surface. The reference states that the authors will focus their efforts on enzymatic reactant system designed for use with two different crosslink chemistries. Furthermore, the reference states that there is currently no commercial available enzyme system which specifically attacks the ether linkage between DMDHEU and cellulose and that there are several protease systems with the potential to degrade the urea linkage in DMDHEU and these will be evaluated.

### SUMMARY OF THE INVENTION

The present inventors have found an enzyme system that improves the strength retention and abrasion resistance of durable finished cellulosic materials such as cotton.

The present invention provides a durable press process that makes cellulosic fiber-containing fabrics, e.g. cotton, linen, ramie, regenerated cellulose, and blends thereof with other fibers such as polyester, nylon etc., wrinkle-free/resistant and at the same time improve performance properties such as breaking strength and abrasion resistance compared to traditional durable press processes by treating the durable press finished cellulosic material with a composition comprising an enzyme capable of removing cross links in the cellulosic material, preferable on the surface of the cellulosic material. The enzymatic treatment may also be carried out during the durable press process to reduce the extent of cross linking especially on the surface of the cellulosic material. In this embodiment the composition comprises besides the enzyme also at least one durable press finishing agent.

Accordingly, in a first embodiment the present invention relates to a method for improving the abrasion resistance and/or tensile strength of a durable press finished cellulosic material comprising enzymatic treatment of the durable press finished material with an enzyme capable of preventing and/or removing crosslinks from the cellulosic material.

In a second aspect, the present invention relates to a composition for treating durable press finished cellulosic materials comprising at least one enzyme capable of preventing and/or removing crosslinks from the cellulosic material.

In a third aspect, the present invention relates to a composition for treating cellulosic materials comprising at least one durable press finishing agent and at least one enzyme capable of preventing and/or removing crosslinks from the cellulosic material.

### DETAILED DESCRIPTION OF THE INVENTION

The present invention is directed to a method for improving the strength retention of durable press finished cellulosic materials.

The term “improving the abrasion resistance and/or tensile strength” means in the context of the present invention that the breaking load and/or tenacity of the durable finished cellulosic material treated with enzyme according to the invention is increased as compared to a durable finished material which has not undergone the enzymatic treatment. Abrasion resistance and tensile strength are physical properties of textiles that are measured by standard methods.

The term “an enzyme capable of preventing and/or removing crosslinks from the cellulosic material” means in the context of the present invention an enzyme that is able to provide improved abrasion resistance and/or tensile strength to the durable press finished cellulosic material as mentioned above.

Fabrics

The term “cellulosic material” or “cellulosic fabric” indicates any type of fabric, in particular woven fabric, prepared from a cellulose-containing material, containing cellulose or cellulose derivatives, e.g. from wood pulp, and cotton. In the present context, the term “fabric” is also intended to include garments and other types of processed fabrics. Examples of cellulosic fabric is cotton, viscose, rayon, ramie, linen, lyocell or mixtures thereof; all blends of viscose, cotton or lyocell with other fibers such as polyester; viscose/cotton blends, lyocell/cotton blends, viscose/wool blends, lyocell/wool blends, cotton/wool blends; flax (linen), ramie and other fabrics based on cellulose fibers, including all blends of cellulosic fibers with other fibers such as wool, polyamide, acrylic and polyester fibers, e.g. viscose/cotton/polyester blends, wool/cotton/polyester blends, flax/cotton blends etc.

The cellulosic material e.g. cotton or cotton blends can be any type of fabric including e.g. woven, non-woven, felt or knit fabrics. Woven fabrics are preferred

Enzymes

The enzymatic process of the invention may be accomplished using any enzyme which is capable of removing crosslinks in the durable press finished material especially removing the crosslinks on the surface of the material.

Ester Hydrolases

The enzymatic process of the Invention may be accomplished using carboxylic ester hydrolases, in particular lipolytic enzyme and/or biopolyester hydrolytic enzyme. Such enzymes are well known and defined in the literature, cf. e.g. Borgström B and Brockman H L, (Eds.); Lipases; Elsevier Science Publishers B.V., 1984, and Kolattukudy P E; The Biochemistry of Plants, Academic Press Inc., 1980 4 624-631.

In the context of this invention lipolytic enzymes are classified in E.C. 3.1.1 and include true lipases, esterases, phospholipases, and lyso-phospholipases. More specifically the lipolytic enzyme may be a lipase as classified by EC 3.1.1.3, EC 3.1.1.23 and/or EC 3.1.1.26, an esterase as classified by EC 3.1.1.1, EC 3.1.1.2, EC 3.1.1.6, EC 3.1.1.7, and/or EC 3.1.1.8, a phospholipase as classified by EC 3.1.1.4 and/or EC 3.1.1.32, a lyso-phospholipase as classified by EC 3.1.1.5 and a cutinase as classified in EC 3.1.1.74.

The lipolytic enzyme preferably is of microbial origin, in particular of bacterial, of fungal or of yeast origin. However, the lipolytic enzyme may also be of mammal origin such as enzyme from porcine liver.

In a particular embodiment, the lipolytic enzyme used may be derived from a strain of Absidia, in particular Absidia blakesleena and Absidia corymbifera, a strain of Achromobacter, in particular Achromobacter iophagus, a strain of Aeromonas, a strain of Alternaria, in particular Alternaria brassiciola, a strain of Aspergillus, in particular Aspergillus niger and Aspergillus flavus, a strain of Achromobacter, in particular Achromobacter iophagus, a strain of Aureobasidium, in particular Aureobasidium pullulans, a strain of Bacillus, in particular Bacillus pumilus, Bacillus strearothermophilus and Bacillus subtilis, a strain of Beauveria, a strain of Brochothrix, in particular Brochothrix thermosohata, a strain of Candida, in particular Candida cylindracea (Candida rugosa), Candida paralipolytica, Candida tsukubaensis, Candida auriculariae, Candida humicola, Cadida foliarum, Candida cylindracea (Cadida rugosa) and Candida antarctica, a strain of Chromobacter, in particular Chromobacter viscosum, a strain of Coprinus, in particular Coprinus cinerius, a strain of Fusarium, in particular Fusarium oxysporum, Fusarium solani, Fusarium solani pisi, and Fusarium roseum culmorum, a strain of Geotricum, in particular Geotricum penicillatum, a strain of Hansenula, in particular Hansenula anomala, a strain of Humicola, in particular Humicola brevispora, Humicula lanuginosa, Humicola brevis var. thermoidea, and Humicola insolens, a strain of Hyphozyma, a strain of Lactobacillus, in particular Lactobacillus curvatus, a strain of Metarhizium, a strain of Mucor, a strain of Paecilomyces, a strain of Penicillium, in particular Penicillium cyclopium, Penicillium crustosum and Penicillium expansum, a strain of Pseudomonas in particular Pseudomonas aeruginosa, Pseudomonas alcaligenes, Pseudomonas cepacia (syn. Burkholderia cepacia), Pseudomonas fluorescens, Pseudomonas fragi, Pseudomonas maltophilia, Pseudomonas mendocina, Pseudomonas mephitica lipolytica, Pseudomonas alcaligenes, Pseudomonas plantari, Pseudomonas pseudoalcaligenes, Pseudomonas putida, Pseudomonas stutzeri, and Pseudomonas wisconsinensis, a strain of Rhizoctonia, in particular Rhizoctonia solani, a strain of Rhizomucor, in particular Rhizomucor miehei, a strain of Rhizopus, in particular Rhizopus japonicus, Rhizopus microsporus and Rhizopus nodosus, a strain of Rhodosporidium, in particular Rhodosporidium toruloides, a strain of Rhodotorula, in particular Rhodotorula glutinis, a strain of Sporobolomyces, in particular Sporobolomyces shibatanus, a strain of Thermomyces, in particular Thermomyces lanuginosus (formerly Humicola lanuginosa), a strain of Thiarosporella, in particular Thiarosporella phaseolina, a strain of Trichoderma, in particular Trichoderma harzianum, and Trichoderma reesei, and/or a strain of Verticillium.

In a more preferred embodiment, the lipolytic enzyme used according to the invention is derived from a strain of Aspergillus, a strain of Achromobacter, a strain of Bacillus, a strain of Candida, a strain of Chromobacter, a strain of Fusarium, a strain of Humicola, a strain of Hyphozyma, a strain of Pseudomonas, a strain of Rhizomucor, a strain of Rhizopus, or a strain of Thermomyces.

In a more preferred embodiment, the lipolytic enzyme used according to the invention is derived from a strain of Bacillus pumilus, a strain of Bacillus stearothermophilus a strain of Candida cylindracea, a strain of Candida antarctica, in particular Candida antarctica Lipase B (obtained as described in WO 88/02775), a strain of Humicola insolens, a strain of Hyphozyma, a strain of Pseudomonas cepacia, or a strain of Thermomyces lanuginosus.

In the context of this invention biopolyester hydrolytic enzyme include esterases and poly-hydroxyalkanoate depolymerases, in particular poly-3-hydroxyalkanoate depolymerases. In fact an esterase is a lipolytic enzyme as well as a biopolyester hydrolytic enzyme.

In a more preferred embodiment, the esterase is a cutinase or a suberinase. Also in the context of this invention, a cutinase is an enzyme capable of degrading cutin, cf. e.g. Lin T S & Kolattukudy P E, J. Bacteriol. 1978 133 (2) 942-951, a suberinase is an enzyme capable of degrading suberin, cf. e.g., Kolattukudy P E; Science 1980 208 990-1000, Lin T S & Kolattukudy P E; Physiol. Plant Pathol. 1980 17 1-15, and The Biochemistry of Plants, Academic Press, 1980 Vol. 4 624-634, and a poly-3-hydroxyalkanoate depolymerase is an enzyme capable of degrading poly-3-hydroxyalkanoate, cf. e.g. Foster et al., FEMS Microbiol. Lett. 1994 118 279-282. Cutinases, for instance, differs from classical lipases in that no measurable activation around the critical micelle concentration (CMC) of the tributyrine substrate is observed. Also, cutinases are considered belonging to a class of serine esterases.

The biopolyester hydrolytic enzyme preferably is of microbial origin, in particular of bacterial, of fungal or of yeast origin.

In a preferred embodiment, the blopolyester hydrolytic enzyme is derived from a strain of Aspergillus, in particular Aspergillus oryzae, a strain of Alternaria, in particular Alternaria brassiciola, a strain of Fusarium, in particular Fusarium solani, Fusarium solani pisi, Fusarium roseum culmorum, or Fusarium roseum sambucium, a strain of Helminthosporum, in particular Helminthosporum sativum, a strain of Humicola, in particular Humicola insolens, a strain of Pseudomonas, in particular Pseudomonas mendocina, or Pseudomonas putida, a strain of Rhizoctonia, in particular Rhizoctonia solani, a strain of Streptomyces, in particular Streptomyces scabies, or a strain of Ulociadium, in particular Ulociadium consortiale. In a most preferred embodiment the biopolyester hydrolytic enzyme is a cutinase derived from a strain of Humicola insolens, in particular the strain Humicola insolens DSM 1800 (see e.g. WO A1 00/34450 and U.S. Pat. No. 6,184,010).

In another preferred embodiment, the poly-3-hydroxyalkanoate depolymerase is derived from a strain of Alcaligenes, in particular Alcaligenes faecalis, a strain of Bacillus, in particular Bacillus megaterium, a strain of Carnomonas, in particular Carnomonas testosteroni, a strain of Penicillium, in particular Penicillium funiculosum, a strain of Pseudomonas, in particular Pseudomonas fluorescens, Pseudomonas lemoignel and Pseudomonas oleovorans, or a strain of Rhodospirillum, in particular Thodospirillum rubrum.

Specific examples of readily available commercial lipases include Lipolase® (WO 98/35026) Lipolase™ Ultra, Lipozyme®, Palatase®, Novozym® 435, Lecitase®) (all available from Novozymes A/S).

Examples of other lipases are Lumafast™, Ps. mendocian lipase from Genencor Int. Inc.; Lipomax™, Ps. pseudoalcaligenes lipase from Gist Brocades/Genencor Int. Inc.; Fusarium solani lipase (cutinase) from Unilever; Bacillus sp. lipase from Solvay enzymes. Other lipases are available from other companies.

Cellulases

In the present context, the term “cellulase” refers to an enzyme which catalyses the degradation of cellulose to glucose, cellobiose, triose and other cello-oligosaccharides.

In the present context the term “cellulase” is understood to include a mature protein or a precursor form thereof or a functional fragment thereof which essentially has the activity of the full-length enzyme. Furthermore, the term “cellulase” is intended to include homologues or analogues of said enzyme. Such homologues comprise an amino acid sequence exhibiting a degree of identity of at least 60% with the amino acid sequence of the parent enzyme, i.e. the parent cellulase. The degree of identity may be determined by conventional methods, see for instance, Altshul et al., Bull. Math. Bio. 48, 1986, pp. 603-616, and Henikoff and Henikoff, Proc. Natl. Acad. Sci. USA 89, 1992, pp. 10915-10919.

Preferably, the cellulase to be used in the present invention is a monocomponent (recombinant) cellulase, i.e. a cellulase essentially free from other proteins or cellulase proteins. A recombinant cellulase component may be cloned and expressed according to standard techniques conventional to the skilled person.

In a preferred embodiment of the invention, the cellulase to be used in the method is an endoglucanase (EC 3.2.1.4), preferably a monocomponent (recombinant) endoglucanase.

Preferably, the cellulase is a microbial cellulase, more preferably a bacterial or fungal cellulase.

Examples of bacterial cellulases are cellulases derived from or producible by bacteria from the group of genera consisting of Pseudomonas or Bacillus, in particular Bacillus lautus.

The cellulase or endoglucanase may be an acid, a neutral or an alkaline cellulase or endoglucanase, i.e. exhibiting maximum cellulolytic activity in the acid, neutral or alkaline range, respectively.

Accordingly, a useful cellulase is an acid cellulase, preferably a fungal acid cellulase, which is derived from or producible by fungi from the group of genera consisting of Trichoderma, Actinomyces, Myrothecium, Aspergillus, and Botrytis.

A preferred useful acid cellulase is derived from or producible by fungi from the group of species consisting of Trichoderma viride, Trichoderma reesei, Trichoderma longibrachiatum, Myrothecium verrucaria, Aspergillus niger, Aspergillus oryzae, and Botrytis cinerea.

Another useful cellulase or endoglucanase is a neutral or alkaline cellulase, preferably a fungal neutral or alkaline cellulase, which is derived from or producible by fungi from the group of genera consisting of Aspergillus, Penicillium, Myceliophthora, Humicola, Irpex, Fusarium, Stachybotrys, Scopulariopsis, Chaetomium, Mycogone, Verticillium, Myrothecium, Papulospora, Gliocladium, Cephalosporium and Acremonium.

A preferred alkaline cellulase is derived from or producible by fungi from the group of species consisting of Humicola insolens, Fusarium oxysporum, Myceliopthora thermophila, or Cephalosporium sp., preferably from the group of species consisting of Humicola insolens, DSM 1800, Fusarium oxysporum, DSM 2672, Myceliopthora thermophila, CBS 117.65, or Cephalosporium sp., RYM-202.

A preferred example of a native or parent cellulase is an alkaline endoglucanase which is immunologically reactive with an antibody raised against a highly purified ^{˜}43 kD endoglucanase derived from Humicola insolens, DSM 1800, or which is a derivative of the ^{˜}43 kD endoglucanase exhibiting cellulase activity.

Other examples of useful cellulases are variants having, as a parent cellulase, a cellulase of fungal origin, e.g. a cellulase derivable from a strain of the fungal genus Humicola, Trichoderma or Fusarium.

Proteolytic Enzymes

Suitable proteases include those of animal, vegetable or microbial origin, preferably of microbial origin. The protease may be a serine protease or a metalloprotease, preferably an alkaline microbial protease or a trypsin-like protease. Examples of proteases include aminopeptidases, including prolyl aminopeptidase (3.4.11.5), X-pro aminopeptidase (3.4.11.9), bacterial leucyl aminopeptidase (3.4.11.10), thermophilic aminopeptidase (3.4.11.12), lysyl aminopeptidase (3.4.11.15), tryptophanyl aminopeptidase (3.4.11.17), and methionyl aminopeptidase (3.4.11.18); serine endopeptidases, including chymotrypsin (3.4.21.1), trypsin (3.4.21.4), cucumisin (3.4.21.25), brachyurin (3.4.21.32), cerevisin (3.4.21.48) and subtilisin (3.4.21.62); cysteine endopeptidases, including papain (3.4.22.2), ficain (3.4.22.3), chymopapain (3.4.22.6), asclepain (3.4.22.7), actinidain (3.4.22.14), caricain (3.4.22.30) and ananain (3.4.22.31); aspartic endopeptidases, including pepsin A (3.4.23.1), Aspergillopepsin I (3.4.23.18), Penicillopepsin (3.4.23.20) and Saccharopepsin (3.4.23.25); and metalloendopeptidases, including Bacillolysin (3.4.24.28).

Non-limiting examples of subtilisins include subtilisin BPN′, subtilisin amylosacchariticus, subtilisin 168, subtilisin mesentericopeptidase, subtilisin Carlsberg, subtilisin DY, subtilisin 309, subtilisin 147, thermitase, aqualysin, Bacillus PB92 protease, proteinase K, protease TW7, and protease TW3.

Commercially available proteases include Alcalase®, Savinase®, Primase®, Duralase®, Esperase®, Kannase®, and Durazym® (Novozymes A/S), Maxatase®), Maxacal®, Maxapem®, Properase®, Purafect®, Purafect OxP®, FN2®, and FN3® (Genencor International Inc.).

Also useful in the present invention are protease variants, such as those disclosed in EP 130.756 (Genentech), EP 214.435 (Henkel), WO 87/04461 (Amgen), WO 87/05050 (Genex), EP 251.446 (Genencor), EP 260.105 (Genencor), Thomas et al., (1985), Nature. 318, p. 375-376, Thomas et al., (1987), J. Mol. Biol., 193, pp. 803-813, Russel et al., (1987), Nature, 328, p. 496-500, WO 88/08028 (Genex), WO 88/08033 (Amgen), WO 89/06279 (Novo Nordisk A/S), WO 91/00345 (Novo Nordisk A/S), EP 525 610 (Solvay) and WO 94/02618 (Gist-Brocades N.V.).

The activity of proteases can be determined as described in “Methods of Enzymatic Analysis”, third edition, 1984, Verlag Chemie, Weinheim, vol. 5.

Process

Any finishing chemical or agent known in the art can be used in the chemical treatment of the fabric to provide a durable press finished fabric, e.g. dimethynol urea, trimethyl triazine, uron, triazone, 4,5-/1,3-disubstituted ethyleneurea, such as 4,5-dihydroxyethylene urea (DHEU) or 4,5-dimethoxyethylene urea (DMEU) or 1,3-dimethylol-4,5-dihydroxyethylene urea (DMDHEU) or tetramethyl ether (DMDMEU) or polycarboxylic acids, or N-substituted methyl carbamates such as 1,2,3,4-butanetetracarboxylic acid (BTCA), maleic acid (MA), itaconic acid (IA), citraconic acid, trans-aconitic acid, dimethylolethyicarbamate (DMEC).

The fabric can be treated using any method of applying the finishing agent to the fabric such as passing the fabric through a bath, padding the treatment onto the fabric etc. It is within the knowledge of the person skilled in the art to determine the temperature, pH, process time etc. to be used in the process of the invention.

It is preferred that the fabric be treated by passing the fabric through a bath of from 5% to 20% by weight of bath of the active agent, preferably about 10%. In order for the fabric to pickup the agent, the agent is typically applied under pressure of from about 20 psi to about 80 psi, preferably about 50 psi.

The finishing agents may be applied in combination with any esterification catalyst that will provide the effect of crosslinking the agent and the cellulose. An example of such a catalyst is sodium hypophosphite. The amount of catalyst depends on the agent used. The preferred amount is in the range of from 1.0% to 15%, preferably about 5% active catalyst based on the weight of the reactant.

After the treatment with the finishing agent the fabric may be cured by methods known in the art. This is typically carried out by drying the fabric in an oven at about 250 degrees F. or higher at approximately 5 to 10 yards per minute. Thereafter the fabric is passed through another dryer set at about 400 degrees F. at about 100 yards per minute. However, different temperatures and speed of the fabric through the heating process may be applied.

The enzymatic treatment of the fabric may be carried out during the chemical treatment with the finishing agents or after the fabric has been treated with the chemical finishing agents. The pH of the enzymatic treatment is in the range of from about 6 to about 10, preferably in the range of from about 7 to about 9 depending on the type of enzyme used. When the enzyme treatment is carried out after the chemical treatment the fabric is typically washed before the enzymatic treatment. The enzymatic treatment is carried out at temperatures and at concentrations of the enzyme suitable for obtaining desired results.

### EXAMPLES

### Example 1

### Treatment with Modified Cutinase from Humicola insolens

White and mercerized 100% cotton fabric (Harbour twill) from Gayley and Lord (style No: 1133090, batch No: 4040) was used for this example. The fabric weighed about 80 oz per square yard. It was used to prepare butane tetracarboxylic acid (BTCA)-cotton fabric.

For BTCA-cotton preparation, a bath was made and was placed in a pad system.

The bath contains:
sodium hypophosphite: 5% w/w
butane tetracarboxylic acid: 10% w/w
water: 85% w/w

The fabric was passed through the BTCA bath and padded under 50 psi/nip pressure at a speed of 5 yard/minute. The fabric was then dried at 250° F. for and cured at 360° F. for at 5 yard/minute. The fabric was dried or cured in about 20 feet long equipment. The BTCA-cotton fabric was cut to 27×45 cm² swatches. The swatches were washed at warm/warm condition for 10 minutes in a typical top loading US washing machine with about 18 gallons water and 20 g/l AATCC standard detergent. Each swatch was weighed about 30-31 g.

BTCA-cotton swatches were first treated together in 0.1N NaOH for 5 minutes and then rinsed in deionized water for about 15 minutes. Excess water was squeezed out by hand prior to enzyme treatment. The enzyme treatment was conducted at 70° C. for 4 hours at liquor to fabric ratio of 10:1 (v/w) in a Labomat (Werner Mathis, NC) at 50 rpm. Table 1 presents the enzyme dose. A protein engineered cutinase originally from the strain Humicola insolens DSM 1800 (Novozymes A/S) was used. The ending pH of treatment was 8.70 and 8.60 for 1-A and 1-B, respectively.

The fabric breaking strength and tenacity were measured with Instron using 25 mm raveled strip (1R-E) according to ASTM D 5035-90. The average value of five samples is shown in Table 1. After washing three times according to AATCC, the appearance of fabric was evaluated by three professionals according to AATCC method 124-1992. The average rating is also shown in Table 1. Compared to no enzyme treatment, fabric treated with cutinase has higher breaking load and tenacity and the same or similar appearance after three laundering cycles.

TABLE 1

| | | Breaking | | Appearance |
|---|---|---|---|---|
| | Cutinase | Load | Tenacity | after 3x |
| Sample | (mg/ml) | (N) | (kg/den) | laundering |
| 1-A | 0 | 497 | 50.7 | 3.3 |
| 1-B | 35.7 | 512 | 52.2 | 3.4 |

### Example 2

### Treatment with Esterase From Porcine Liver

The BTCA-cotton swatches used in this example were the same as in example 1. Swatches were first treated in 0.1N NaOH for 5 minutes and then rinsed in deionized water for about 15 minutes. Excess water was squeezed out by hand prior to enzyme treatment. The enzyme treatment was conducted at 50° C. for 2 hours at liquor to fabric ratio of 10:1 (v/w) in a Labomat (from Werner Mathis, NC) at 50 rpm. Table 2 shows the enzyme dose. The esterase from porcine liver was purchased from SIGMA-Aldrich (E-3019). The ending pH of treatment was 9.05 and 8.85 for 2-A and 2-B, respectively.

The fabric breaking strength and tenacity were measured with Instron using 25 mm raveled strip (1R-E) according to ASTM D 5035-90. The average value of five samples is shown in Table 2. After washing three times according to AATCC, the appearance of fabric was evaluated by three professionals according to AATCC method 124-1992. The average rating is also shown in Table 2. Compared to no enzyme treatment, fabric treated with esterase has higher breaking load, higher tenacity, and better appearance after three laundering cycles.

TABLE 2

| | | | | Appearance |
|---|---|---|---|---|
| | Esterase | Breaking Load | Tenacity | after 3x |
| Sample | (mg/ml) | (N) | (kg/den) | laundering |
| 2-A | 0 | 483 | 49.2 | 3.2 |
| 2-B | 2.44 | 499 | 50.9 | 3.5 |

### Example 3

### Treatment with cutinase from humicola insolens

The original 100% cotton was used for comparison, which has no BTCA. BTCA-cotton swatches were the same as in example 1. The enzyme treatment was conducted at 65° C. for 1 hour at liquor to fabric ratio of 10:1 (v/w) in a Labomat (from Werner Mathis, NC) at 50 rpm. Sodium phosphate buffer (5 mM and pH 7.5) was used in this example. Table 3 shows the enzyme dose. A protein engineered cutinase originally from the strain Humicola insolens DSM 1800 (Novozymes A/S) was used. The ending pH of treatment is shown in Table 3.

The fabric breaking strength and tenacity were measured with Instron using 25 mm raveled strip (1R-E) according to ASTM D 5035-90. The average value of five samples is shown in Table 3. After washing three times according to AATCC, the appearance of fabric was evaluated by three professionals according to AATCC method 124-1992. The average rating is also shown in Table 3. Compared to fabric with non-BTCA, BTCA-cotton fabric has much lower tensile strength, but much higher appearance after laundering for 3 times. Compared to no enzyme treatment, fabric treated with 35.7 mg/ml cutinase has higher breaking load and the same appearance after three laundering cycles.

TABLE 3

| | | | | Appearance |
|---|---|---|---|---|
| | Cutinase | Tensile | Ending | after 3x |
| Sample | (mg/ml) | W + F | Ph | laundering |
| 100% cotton | 0 | 180 117 | 7.68 | 1.2 |
| BTCA-cotton | 0 | 133 83 | 6.30 | 3.0 |
| BTCA-cotton | 35.7 | 135 86 | 6.46 | 3.0 |

### Example 4

### Treatment DMDHEU-Cotton With Cellulases

White and mercerized 100% cotton fabric (Harbour twill) from Gayley and Lord (style No: 1133090, batch No: 4040) was used for this example. The fabric weighed about 80 oz per square yard. It was used to prepare cotton crosslinked with dimethyloldihydroxy-ethylene urea (DMDHEU). The DMDHEU-Cotton was prepared according to the procedure described on page 138-140 in Cotton Dyeing and Finishing—A Technical Guide published by Cotton Incorporated in 1996.

The DMDHEU-cotton fabric was cut to 50×26 cm² swatches. Each swatch was about 32 g. The swatches were washed in a top loading washing machine with 20 g AATCC standard detergent in hot water for 10 minutes and then rinsed twice in cold water prior to this experiment.

DMDHEU-cotton swatches were treated with cellulases in launder-o-meter at 55° C. for 2 hours with 28 balls/beaker. The launder-o-meter was rotating at 42 rpm during the treatment. Buffers were 20 mM sodium acetate pH 5.0 and 20 mM sodium phosphate pH 7.0. Cellulases were Cellusoft® L (Trichoderma), Denimax® L (Humicola), EG V (Humicola insolens) and EG V without cellulose binding domain (i.e. EG V core from Humicola) with activities of 750 EGU/g, 90 EGU/g, 4585 ECU/g, and 6580 ECU/g, respectively. All cellulases are available from Novozymes A/S. The EGU and ECU activities were measured using carboxyl-methyl cellulose (CMC) according to AF 275/1-GB and AF 302.1/1-GB, respectively. The treatment with Trichoderma cellulases carried out at pH 5 and with Humicola cellulases at pH 7.

Table 4 shows the strength results from the Instron using 25 mm raveled strip (1R-E) according to ASTM D 5035-90. The average strength and tenacity value of at least three samples was given. After washing three times according to AATCC, the appearance of fabric was evaluated by three professionals according to AATCC method 124-1992. All swatches had the same or undistinguishable appearance.

TABLE 4

| | | | Breaking Load | Tenacity |
|---|---|---|---|---|
| Swatch | Enzyme Type | Enzyme Dose | (N) | (kg/den) |
| 1 | Cellusoft L | 0 (% owg*) | 575 | 5.87 |
| 2 | | 1 (% owg) | 586 | 5.97 |
| 3 | | 2 (% owg) | 581 | 5.93 |
| 4 | Denimax L | 0 (% owg) | 596 | 6.07 |
| 5 | | 3 (% owg) | 603 | 6.15 |
| 6 | | 6 (% owg) | 597 | 6.09 |
| 7 | EG V Core | 0 ECU/g fabric | 596 | 6.07 |
| 8 | | 50 ECU/g fabric | 605 | 6.17 |
| 9 | | 100 ECU/g fabric | 618 | 6.30 |
| 10 | EG V | 0 ECU/g fabric | 596 | 6.07 |
| 11 | | 15 ECU/g fabric | 623 | 6.36 |
| 12 | | 30 ECU/g fabric | 610 | 6.22 |

*% owg is % of enzyme on weight of good (i.e. fabric).

### Example 5

### Treatment of DMDHEU-Cotton With Proteases

Harbour twill from Gayley and Lord (style No: 1133090, batch No: 4040) was the same as in example 4. The DMDHEU-Cotton was prepared in the same way as in examples 4. The DMDHEU-cotton fabric was cut and washed in a top loading washing machine with 20 g AATCC standard detergent in hot water for 10 minutes and then rinsed twice in cold water prior to this experiment.

DMDHEU-cotton swatches (one swatch/beaker) were treated with proteases in launder-o-meter at 55° C. for 2 hours with 28 balls/beaker. The launder-o-meter was rotating at 42 rpm during the treatment. The protease treatments were conducted within 20 mM sodium phosphate buffer pH8.5. using Alcalase® (Novozymes A/S) with an activity of 2.5 AU/g. The Alcalase® activity was measured using automated kinetic assay procedures described in publication AF 218.

Table 5 SHOWS the strength results from the Instron using 25 mm raveled strip (1 R-E) according to ASTM D 5035-90. The average strength and tenacity value of at least three samples IS SHOWN. After washing three times according to AATCC, the appearance of fabric was evaluated by three professionals according to AATCC method 124-1992. All swatches had the same or undistinguishable appearance.

TABLE 5

| | | Enzyme Dose | Breaking Load | Tenacity |
|---|---|---|---|---|
| Swatch | Enzyme Type | (μl) | (N) | (kg/den) |
| 1 | Alcalase ® | 0 | 628 | 6.40 |
| 2 | | 150 | 654 | 6.67 |
| 3 | | 450 | 640 | 6.53 |

1. A method for improving the abrasion resistance and/or tensile strength of a durable press finished cellulosic material comprising enzymatic treatment of the durable press finished material with an enzyme capable of preventing and/or removing crosslinks from the cellulosic material.

2. The method of claim 1, wherein the durable press finished cellulosic material is obtained by contacting the cellulosic material with a chemical finishing agent under conditions suitable to obtain cross linking of the cellulosic material.

3. The method of claim 1, wherein the cellulosic material is selected from the group consisting of cotton, viscose, rayon, ramie, linen, lyocell and mixtures thereof.

4. The method of claim 1, wherein the chemical finishing agent is selected from the group consisting of dimethynol urea, trimethyl triazine, uron, triazone, 4,5-/1,3-disubstituted ethyleneurea, polycarboxylic acids, N-substituted methyl carbamates, maleic acid (MA), itaconic acid (IA), citraconic acid, trans-aconitic acid and dimethylolethylcarbamate (DMEC).

5. The method of claim 4, wherein the chemical finishing agent is 4,5-dihydroxyethylene urea (DHEU), 4,5-dimethoxyethylene urea (DMEU), 1,3-dimethylol-4,5-dihydroxyethylene urea (DMDHEU), tetramethyl ether (DMDMEU) or 1,2,3,4-butanetetracarboxylic acid (BTCA).

6. The method of claim 1, wherein the enzymes are selected from the group consisting of ester hydrolases, cellulases and proteolytic enzymes.

7. The method of claim 6, wherein the enzyme is a cutinase.

8. The method of claim 7, wherein the cutinase is derived from the strain Humicula insolens.

9. The method of claim 8, wherein the cutinase is derived from the strain Humicula insolens DSM 1800.

10. The method of claim 6, wherein the enzyme is an esterase.

11. The method of claim 6, wherein the cellulases is derived from a strain selected from he group consisting of Trichoderma and Humicola.

12. The method of claim 1, wherein the cross links are located on the surface of the cellulosic material.

13. A composition for treating durable press finished cellulosic materials comprising at least one enzyme capable of preventing and/or removing crosslinks from the cellulosic material.

14. The composition of claim 13, wherein the enzymes are selected from the group consisting of ester hydrolases, cellulases and proteolytic enzymes.

15. The composition of claim 14, wherein the enzyme is a cutinase.

16. The composition of claim 15, wherein the cutinase is derived from the strain Humicula insolens.

17. The composition of claim 16, wherein the cutinase is derived from the strain Humicula insolens DSM 1800.

18. The composition of claim 14, wherein the enzyme is an esterase.

19. The composition of claim 14, wherein the cellulase is derived from a strain selected from the group consisting of Trichoderma and Humicola.

20. A composition for treating cellulosic materials comprising at least one durable press finishing agent and at least one enzyme capable of preventing and/or removing crosslinks from the cellulosic material.

21. The composition of claim 20, wherein the durable press finishing agent is selected from the group consisting of dimethynol urea, trimethyl triazine, uron, triazone, 4,5-/1,3-disubstituted ethyleneurea, polycarboxylic acids, N-substituted methyl carbamates, maleic acid (MA), Itaconic acid (IA), citraconic acid, trans-aconitic acid and dimethylolethylcarbamate (DMEC).

22. The composition of claim 21, wherein the chemical finishing agent is 4,5-dihydroxyethylene urea (DHEU), 4,5-dimethoxyethylene urea (DMEU), 1,3-dimethylol-4,5-dihydroxyethylene urea (DMDHEU), tetramethyl ether (DMDMEU) or 1,2,3,4-butanetetracarboxylic acid (BTCA).

23. The composition of claim 20, wherein the enzymes are selected from the group consisting of ester hydrolases, cellulases and proteolytic enzymes.

24. The composition of claim 23, wherein the enzyme is a cutinase.

25. The composition of claim 24, wherein the cutinase is derived from the strain Humicula insolens.

26. The composition of claim 25, wherein the cutinase is derived from the strain Humicula insolens DSM 1800.

27. The composition of claim 23, wherein the enzyme is an esterase.

28. The composition of claim 23, wherein the cellulase is derived from a strain selected from the group consisting of Trichoderma and Humicola.
